(19) United States
(12) Patent Application Publication
(10) Pub. No.: US 2014/0259025 A1
(43) Pub. Date: Sep. 11, 2014

(54) METHOD AND APPARATUS FOR PARALLEL COMPUTING

(71) Applicant: EMC Corporation, Hopkinton, MA (US)

(72) Inventors: Dong Xiang, Shanghai (CN); Yu Cao, Beijing (CN); Jun Tao, Shanghai (CN)

(73) Assignee: EMC Corporation, Hopkinton, MA (US)

(21) Appl. No.: 14/197,638

(22) Filed: Mar. 5, 2014

(30) Foreign Application Priority Data
Mar. 7, 2013 (CN) CN201310078391.4

(51) Int. Cl. G06F 9/52

(52) U.S. Cl. CPC G06F 9/52
USPC 718/106

(57) ABSTRACT

The present invention relates to a method and apparatus for parallel computing. According to one embodiment of the present invention, there is provided a job parallel processing method, the job processing at least comprising executing an upstream task in a first phase and executing a downstream task in a second phase. The method comprises: quantitatively determining data dependence between the upstream task and the downstream task; and selecting time for initiating the downstream task at least partially based on the data dependence. There is further disclosed a corresponding apparatus. According to embodiments of the present invention, it is possible to more accurately and quantitatively determine data dependence between tasks during different phases and thus select the right time to initiate a downstream task.

### RELATED APPLICATION

This application claims priority from Chinese Patent Application Serial No. CN201310078391.4 filed on Mar. 7, 2013 entitled “Method and Apparatus for Parallel Computing,” the content and teachings of which are hereby incorporated by reference in their entirety.

### FIELD OF THE INVENTION

Embodiments of the present invention relate to a method and apparatus for parallel computing.

### BACKGROUND OF THE INVENTION

Parallel computing has been put into growingly wide application. Accordingly, one job may be divided into multiple tasks or task phases. Tasks in each phase may be dispatched to multiple different nodes so as to be executed in parallel. Data generated in the last phase (called “intermediate data”) is transmitted to a task in the subsequent phase for further processing. In the same phase there may exist multiple tasks that can be executed concurrently, while there is data dependency between tasks in different phases. In parallel or distributed computation, an important consideration is data dependency between different task phases.

Take the MapReduce model as an example which is typically used for parallel job processing. The model divides a single job into two phases: Map phase and Reduce phase. As is well known in the art, during each of the Map phase and Reduce phase, there may exist a plurality of concurrently executable tasks; while there is data dependency between these two phases. Map tasks will generate intermediate data, which can be stored by means of a diskette and transmitted via a network to Reduce tasks as the input. A Reduce task needs to completely fetch its corresponding intermediate data from each Map task before it begins to perform subsequent data processing. As such, it is unnecessary to initiate Map tasks and Reduce tasks at the same time. Common prior art practice is that the Reduce tasks are initiated when the number of completed Map tasks reaches a predetermined threshold (e.g. 5%).

In prior art, generally the time to initiate Reduce tasks is determined based on a static rule. For example, based on this static scheme, some Reduce tasks might be initiated earlier than actually required, and thus fall in idle status, causing a waste of resources allocated to perform these Reduce tasks. Further, other concurrent Reduce tasks may be negatively affected due to potential resource starvation. Also, the static rule as disclosed in prior art might also cause some Reduce tasks to be initiated too late. This will increase the job's overall execution time and in turn lead to a response delay.

It should be understood that problems created by data dependency between tasks performed at different phases widely exist in various parallel or distributed computation, but not limited to the MapReduce model that has been described here by way of example. Generally in job parallelization processing, earlier initiation of downstream tasks will result in a waste of resources, while later initiation of downstream tasks will tend to lower the overall task execution efficiency, adversely impacting the overall job execution efficiency.

### SUMMARY

In view of the above and other potential problems, there is a need in the art for a solution to more efficiently manage parallel computing as static rules cannot necessarily ensure that a specific job has a higher execution efficiency.

According to an embodiment of the present invention, there is provided a method for parallel job processing, wherein the job processing comprises at least one of executing an upstream task in a first phase and executing a downstream task in a second phase. The method further comprises: quantitatively determining data dependency between the upstream task and the downstream task; and selecting a time for initiating the downstream task at least partially based on the data dependency.

A further embodiment of the present invention, there is provided a parallel job processing apparatus, the job processing at least comprising executing an upstream task in a first phase and executing a downstream task in a second phase. The apparatus further comprises: a determining unit configured to quantitatively determine data dependency between the upstream task and the downstream task; and further configured to select time, which may also be done by a separate selecting unit, for initiating the downstream task at least partially based on the data dependency.

As will be understood from the following description, according to embodiments of the present invention, it is allowed to characterize or model data dependency between tasks performed during different phases of a parallelization job processed in a quantitative manner, wherein the initiation time of a downstream task can be selected more precisely. In this way, it is possible to avoid resource idleness and waste caused by the earlier initiation of any downstream task and at the same time prevent a later initiation of the downstream task from lowering the overall execution efficiency for a job and prolonging the response time.

### BRIEF DESCRIPTION OF THE DRAWINGS

Through the more detailed description in the accompanying drawings, the above and other objects, features and advantages of embodiments of the present invention will become more apparent. In all the figures same or corresponding numerals represent the same or corresponding portions. Several embodiments of the present invention are illustrated schematically and are not intended to limit the present invention. In the drawings:

FIG. 1 shows a flowchart of a job parallel processing method according to one exemplary embodiment of the present invention;

FIG. 2 shows a flowchart of a job parallel processing method according to another exemplary embodiment of the present invention;

FIG. 3 shows a block diagram of a job parallel processing apparatus according to one exemplary embodiment of the present invention; and

FIG. 4 shows a block diagram of a computer system which may be used in connection with the exemplary embodiments of the present invention.

### DETAILED DESCRIPTION

Principles and spirit of the present disclosure will be described below with reference to the accompanying drawings, where several exemplary embodiments have been illustrated. These embodiments are presented only to enable those skilled in the art to better understand and further implement the present invention, rather than to limit the scope of the present disclosure in any way.

As to be understood from the following description, the present disclosure is related to determine data dependency between an upstream task and a downstream task of a job in a quantitative way, that is specific to each concrete parallelization job. The time to initiate the downstream task can be determined using the data dependency. As such, it becomes possible to avoid resource idleness and waste caused by the earlier initiation of the downstream task, and at the same time to prevent the later initiation of the downstream task from lowering the overall execution efficiency and prolonging the response time for the jobs.

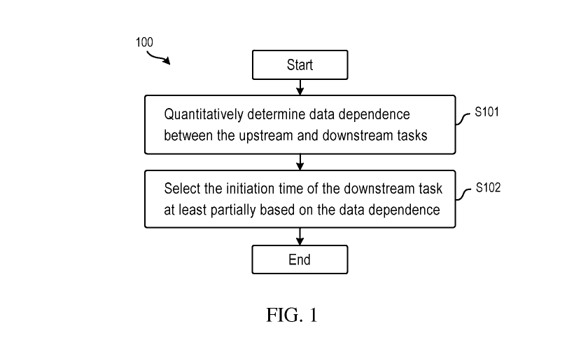

With reference to FIG. 1 first, the figure shows a flowchart of a parallel processing job method according to one embodiment of the present invention. Note the term “job” used here refers to any computation task, such as data analysis, data processing, data mining, etc. In particular, according to embodiments of the present invention, the job processing at least includes executing an upstream task in a first phase and executing a downstream task in a second phase. In other words, task processing may be divided into tasks in different phases. With reference to the present disclosure, tasks that are executed first are called “upstream tasks,” while tasks that are executed subsequently are called “downstream tasks.”

According to embodiments of the present invention, during the job processing procedure, tasks in the same phase may be executed concurrently, while tasks in different phases may be sequentially executed in a temporal order. In particular, it should be understood that upstream tasks and downstream tasks are relative to one another. For a task in a current phase of a job, it may be a downstream task of tasks in a previous phase, and also an upstream task of tasks in a subsequent phase. As an example, during the MapReduce model-based parallel job processing, tasks in the Map phase (or referred to as Map tasks for short) are upstream tasks that are relative to tasks in the Reduce phase (or referred to as Reduce tasks for short), which are downstream tasks relative to Map tasks.

As shown in FIG. 1, after method 100 starts, at step S101 data dependency between an upstream task and a downstream task is determined quantitatively. As is clear to those skilled in the art, there is always data dependency between upstream tasks and downstream tasks. For example, downstream tasks may be executed depending on intermediate data or files generated by upstream tasks. In the prior art, data dependency between upstream tasks and downstream tasks is not quantified with respect to a specific job. For example, as described previously, in the traditional MapReduce model, dependence between upstream tasks and downstream tasks is roughly represented using a static predetermined rule.

Unlike the prior art, according to embodiments of the present invention, data dependency between an upstream task and a downstream task is quantitatively represented or characterized. In this manner, accurate quantitative data dependency can be obtained for any given job. According to embodiments of the present invention, data dependency may be quantitatively characterized or modeled by any proper means, which will be described below.

Next, method 100 proceeds to step S102 where the time of downstream task is selected at least partially based on the data dependency determined in step S101. According to embodiments of the present invention, since data dependency is quantitatively determined with respect to a concrete job, it can be ensured that downstream tasks are initiated at the most proper/appropriate time. Specifically, since data dependency can be quantified, it can be ensured that downstream tasks should not be initiated earlier, thereby avoiding a potential waste of resources. It can be further ensured that downstream tasks will not be initiated later, thereby preventing the job processing time from being prolonged.

Method 100 ends after step S102.

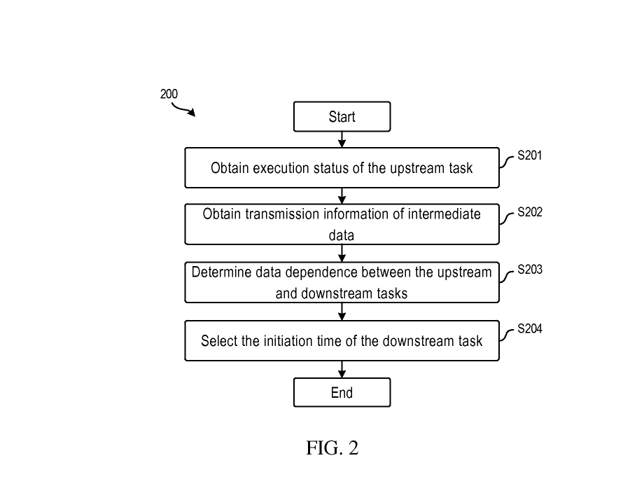

Next with reference to FIG. 2, that shows a flowchart of a parallel processing job method 200 according to a further exemplary embodiment of the present invention. Method 200 may be regarded as a more concrete implementation of the above-described method 100.

After method 200 starts, execution status of the upstream task is obtained at step S201. As will be described below, the obtained execution status will be used for quantitatively determining data dependency between the upstream task and the downstream task. Here the execution status of the upstream task may comprise any information related to execution of the upstream task, such as computing capability of a node for executing the upstream task, data scale of the job itself, amount of data input, amount of data output, data generating rate, current execution progress, resource contention, etc., which are only examples for the purpose of illustration and are not intended to limit the scope of the present disclosure.

In particular, in some embodiments the execution status of the upstream task as obtained at step S201 may comprise estimating the remaining execution time of the upstream task. Specifically, first average execution speed S_{avg} of the upstream task may be computed in the unit of resource slot, and the average execution speed is then used as estimated execution speed of the remaining portion of the upstream task. In addition, the data amount to be processed by the upstream task may be obtained and recorded as Dᵣₑₘ. The remaining data amount Dᵣₑₘ may be obtained by subtracting the data amount processed by the upstream task from the total data amount to be processed. Therefore, the remaining execution time Tᵣₑₘ for the upstream task may be estimated as below: (suppose the amount of computing resources available to a node for executing the upstream task is R in the unit of resource slot,)

Tᵣₑₘ=Dᵣₑₘ/(S_{avg}*R)

In some embodiments, for estimating remaining execution time of the upstream task, resource contention of the upstream task may further be taken into consideration. For example, suppose the probability an upstream task for obtaining required resources is Pₘ. In this case, the above formula for estimating remaining execution time for the upstream task may further be refined as:

Tₘ=Dᵣₑₘ/(S_{avg}*(R*Pₘ))

Next, method 200 proceeds to step S202 where information on transmission of intermediate data generated by the upstream task to the downstream task is obtained. As is clear to those skilled in the art, intermediate files generated by the upstream task will be transmitted by means of a specific medium (e.g. a network, a diskette, etc.) to the downstream task as input, so that the downstream task can execute subsequent data processing. It can be understood that the transmission of the intermediate data has some impact on time for initiating the downstream task. Therefore, according to embodiments of the present invention, such information on the transmission is taken into consideration while quantifying data dependency between the upstream task and the downstream task.

For example according to some embodiments of the present invention, the information on transmission obtained at step S202 may include estimation of the transmission time to transmit the intermediate data to the downstream task. To this end, first average data generating rate (recorded as ER) of the upstream task may be computed. According to one embodiments, ER may be calculated as below:

ER=D_{cur}/D_{fin}

where D_{fin} is the amount of data input that is processed by the upstream task, and D_{cur} is the amount of intermediate data that is currently generated by the upstream task.

Only an exemplary embodiment for estimating the average data generating rate ER has been described above. Alternatively, in some other embodiments the average data generating rate ER of the upstream task may be determined using standard techniques from the database query optimization literature. For example, for pre-defined functions (such as joins and filtering) in Map tasks of the MapReduce model, ER can be estimated using analytical cost formulae. As for other PRE-defined Map functions, debug runs of the same MapReduce job on some samples of the data input can be leveraged to estimate the data selectivity of the Map function, and ER can be computed. The above and other optional means for estimating the data emission rate ER of the upstream task are well known to those skilled in the art and thus are not discussed in detail here.

Next, the total amount of intermediate data generated by the upstream task can be estimated using the formula below:

Dᵢ=D*ER

where D is the total amount of data input of the upstream task, and ER is the above-described average data generating rate of the upstream task.

Thus, the transmission time Tᵢ of the intermediate data between the upstream task and the downstream task can be estimated using the formula below:

Tᵢ=Dᵢ/(N*S)

where S is the average data transmission bandwidth between nodes (e.g. network bandwidth in transmission using a network), and N is the total number of downstream tasks (suppose each downstream task will consume 1/N of the total amount of the intermediate data).

Then method 200 proceeds to S203 where the data dependency between the upstream task and the downstream task is quantitatively determined at least partially based on the upstream task execution status obtained at step S201 and the intermediate data information on transmission obtained at step S203. For the purpose of illustration only, considering the above-described exemplary embodiment, wherein the upstream task execution status comprises the remaining execution time Tᵣₑₘ of the upstream task, and the information on transmission comprises the transmission time Tᵢ to transmit the intermediate data to the downstream task. When Tᵣₑₘ>Tᵢ, it can be considered that the downstream task still has data dependency on the upstream task, so the downstream task is not initiated. On the contrary, when Tᵣₑₘ≦Tᵢ, it can be considered that data dependency of the downstream task on the upstream task has been removed, so the downstream task can be initiated, which will be described below. Unlike the prior art, data dependency between the upstream task and the downstream task is quantitatively reflected by comparison and relationship between values.

Method 200 proceeds to step S204 where time for initiating the downstream task is selected based on the data dependency quantitatively determined at step S203. Considering the above-described example, according to some embodiments, the transmission time Tᵢ may be computed when starting to process the job. Of course, Tᵢ may be updated at any subsequent time point. The remaining execution time Tᵣₑₘ of the upstream task may be computed periodically during the job processing. Every time Tᵣₑₘ is computed or updated, a judgment is made as to whether the following quantitative relationship (represented as an inequality) is established or not:

Tᵣₑₘ>Tᵢ

During job processing, once it is found the inequality is not established, i.e. the remaining execution time of the upstream task gets less than or equal to the transmission time to transmit the intermediate data to the downstream task, the downstream task is initiated immediately. The initiation of the downstream task may be completed by sending a resource allocation request to a resource scheduler, which is well known to those skilled in the art and thus is not discussed here.

According to some embodiments of the present invention, at step S204, the selecting time for initiating the downstream task may further take into consideration resource contention of the downstream task. For example, the time for a downstream node to obtain resources for executing the processing, i.e. the initiation time (recorded as Tᵢₙᵢ) of the downstream node may be estimated according to the number of nodes executing the downstream task and the amount of available resources. In these embodiments, the inequality considered at step S204 may change to:

Tᵣₑₘ>Tᵢ+Tᵢₙᵢ

During the job processing, the execution of the downstream task will be initiated in response to the above inequality not being established, i.e. the remaining execution time of the upstream task being less than or equal to the sum of the transmission time of the intermediate data and the initiation time of the downstream node.

Method 200 ends after completion of step S204.

Described above is a model for modeling data dependency on the basis of the remaining execution time of the upstream task and the transmission time of the intermediate data, which is merely exemplary in nature, and the scope of the present invention is not limited thereto. For example, in some alternative embodiments, the data dependency may further be quantified according to the size of the data input that is to be processed by the upstream task. As another example, the data dependency between the upstream and downstream tasks may be characterized according to the ratio of the amount of the intermediate data generated by the upstream task to the amount of the intermediate data processed by previously executed downstream tasks. In fact, based on the teaching provided by the present disclosure, those skilled in the art may contemplate any proper means to characterize or model the data dependency between the upstream task and the downstream task. Accordingly, all these variations fall under the scope of the present disclosure.

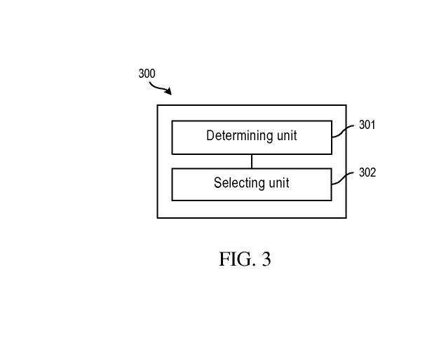

Next with reference to FIG. 3, that shows a block diagram of a parallel job processing apparatus according to one exemplary embodiment of the present invention. As described above, processing a to-be-processed job at least comprises executing an upstream task in a first phase and executing a downstream task in a second phase.

As shown in this figure, apparatus 300 comprises: a determining unit 301 configured to quantitatively determine data dependency between the upstream task and the downstream task; and a selecting unit 302 configured to select time for initiating the downstream task at least partially based on the data dependency.

According to an embodiments, determining unit 301 may further comprise: a first obtaining unit configured to obtain the execution status of the upstream task; and a second obtaining unit configured to obtain information on transmission of intermediate data generated by the upstream task towards the downstream task. It should also be obvious that the function of the first obtaining unit and the second obtaining unit can be built into a single obtaining unit (not illustrated in the figure) or into determining unit 301 itself. In these embodiments, determining unit 301 may further be configured to determine the data dependency at least partially based on the execution status and the information on transmission. In addition, the first obtaining unit may comprise a unit configured to estimate the remaining execution time of the upstream task. Optionally, the remaining execution time of the upstream task is estimated at least partially based on resource contention of the upstream task phase. Accordingly, the second obtaining unit comprises a unit configured to estimate transmission time of the intermediate data to the downstream task. Again the subunits disclosed may be combined into the parent unit (not illustrated in the figures)

According to some embodiments, determining unit 301 may comprise a unit configured to characterize the data dependency by using the remaining execution time of the upstream task and the transmission time of the intermediate data. Optionally, selecting unit 302 may comprise: a unit configured to initiate the downstream task in response to the remaining execution time of the upstream task being less than or equal to the transmission time of the intermediate data. These additional units disclosed here as separate entities, can in one embodiment be part of the parent unit itself.

According to some embodiments, apparatus 300 may further comprise: an estimating unit configured to estimate resource contention of the downstream task. In these embodiments, time for initiating the downstream task is selected based on the data dependence and the resource contention of the downstream task. This estimating unit can be inbuilt into the determining unit or the selecting unit in one embodiment.

In particular, as an example the to-be-processed job may be processed based on the MapReduce model. In these embodiments, the upstream task may comprise a Map task, and the downstream task may comprise a Reduce task.

For the clarity purpose, FIG. 3 does not show optional units of apparatus 300 and sub-units contained in each unit. It should also be obvious that tasks performed by the optional units or the sub-units can be built into the parent units itself. However, it should be understood that apparatus 300 corresponds to the various steps of methods 100 and 200 described above with reference to FIGS. 1 and 2. Hence, all features described with respect to FIGS. 1 and 2 are also applicable and can be implemented using apparatus 300 and are thus not detailed here.

It should be understood that apparatus 300 may be implemented in various forms. For example, in some embodiments each means of apparatus 300 may be implemented using software and/or firmware, wherein each unit is a program module that achieves its function by computer instructions. Alternatively or additionally, apparatus 300 may be implemented partially or completely based on hardware. Additionally, apparatus 300 may be a combination of software and/or firmware and/or hardware. For example, apparatus 300 may be implemented as an integrated circuit (IC) chip, application-specific integrated circuit (ASIC) or system on chip (SOC). Other forms that are currently known or to be developed in future are also feasible, and should not restrict the interpretation or be a limitation to the understanding of the scope of the present disclosure.

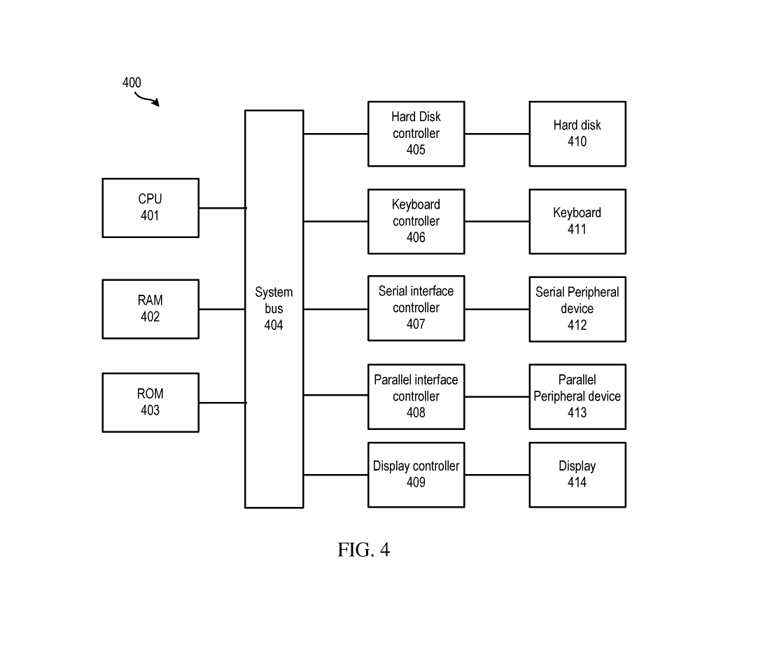

FIG. 4 illustrates a schematic block diagram of a computer system which may be advantageously used in implementing embodiments of the present invention. Illustrated is a computer system, but it should be obvious to one skilled in the art than any processing device that has a processor and a memory should be capable of implementing embodiments of the present invention. As illustrated in FIG. 4, the computer system may include: CPU (Central Process Unit) 401, RAM (Random Access Memory) 402, ROM (Read Only Memory) 403, System Bus 404, Hard Drive Controller 405, Keyboard Controller 406, Serial Interface Controller 407, Parallel Interface Controller 408, Display Controller 409, Hard Drive 410, Keyboard 411, Serial Peripheral Equipment 412, Parallel Peripheral Equipment 413 and Display 414. Among above devices, CPU 401, RAM 402, ROM 403, Hard Drive Controller 405, Keyboard Controller 406, Serial Interface Controller 407, Parallel Interface Controller 408 and Display Controller 409 are coupled to the System Bus 404. Hard Drive 410 is coupled to Hard Drive Controller 405. Keyboard 411 is coupled to Keyboard Controller 406. Serial Peripheral Equipment 412 is coupled to Serial Interface Controller 407. Parallel Peripheral Equipment 413 is coupled to Parallel Interface Controller 408. And, Display 414 is coupled to Display Controller 409. It should be understood that the structure as illustrated in FIG. 4 is only for an exemplary purpose rather than any limitation being made to the present disclosure. In some cases, some devices may be added to or removed from the computer system 400 based on specific situations.

As described above, apparatus 300 may be implemented as hardware, such as a chip, ASIC, SOC, etc. These hardware may be integrated in computer system 400. In addition, embodiments of the present invention may further be implemented in the form of a computer program product. For example, the methods of the present disclosure may be implemented by a computer program product. The computer program product may be stored in RAM 402, ROM 403, Hard Drive 410 as shown in FIG. 4 and/or any appropriate storage media, or be downloaded to computer system 400 from an appropriate location via a network. The computer program product may include a computer code portion that comprises program instructions executable by an appropriate processing device (e.g., CPU 401 shown in FIG. 4). The program instructions at least may comprise program instructions used for executing the steps of the methods of the present invention.

Embodiments of the present invention can be implemented in software, hardware or combination of software and hardware. The hardware portion can be implemented by using dedicated logic; the software portion can be stored in a memory and executed by an appropriate instruction executing system such as a microprocessor or dedicated design hardware. Those of ordinary skill in the art may appreciate the above system and method can be implemented by using computer-executable instructions and/or by being contained in processor-controlled code, which is provided on carrier media like a magnetic disk, CD or DVD-ROM, programmable memories like a read-only memory (firmware), or data carriers like an optical or electronic signal carrier. The system of the present invention can be embodied as semiconductors like very large scale integrated circuits or gate arrays, logic chips and transistors, or hardware circuitry of programmable hardware devices like field programmable gate arrays and programmable logic devices, or software executable by various types of processors, or a combination of the above hardware circuits and software, such as firmware.

Note although several means or sub-means of the system have been mentioned in the above detailed description, such division is merely exemplary and not mandatory. In fact, according to embodiments of the present invention, the features and functions of two or more means described above may be embodied in one means. On the contrary, the features and functions of one means described above may be embodied by a plurality of means.

In addition, although in the accompanying drawings operations of the method of the present disclosure are described in specific order, it is not required or suggested these operations be necessarily executed in the specific order or the desired result be achieved by executing all illustrated operations. On the contrary, the steps depicted in the flowcharts may change their execution order. Additionally or alternatively, some steps may be omitted, a plurality of steps may be combined into one step for execution, and/or one step may be decomposed into a plurality of steps for execution.

Although the present disclosure has been described with reference to several embodiments, it is to be understood the present invention is not limited to the embodiments disclosed herein. The present disclosure is intended to embrace various modifications and equivalent arrangements comprised in the spirit and scope of the appended claims. The scope of the appended claims accords with the broadest interpretation, thereby embracing all such modifications and equivalent structures and functions.

What is claimed is:

1. A method for parallel processing of a job, the method comprising:
quantitatively determining data dependency between an upstream task and a downstream task, wherein processing of the job comprises at least first executing the upstream task and subsequently executing the downstream task; and
selecting a time for initiating the downstream task at least partially based on the data dependency.

2. The method according to claim 1, wherein determining data dependency comprises:
obtaining an execution status of the upstream task;
obtaining an information on transmission of intermediate data generated by the upstream task towards the downstream task; and
determining the data dependency at least partially based on the execution status and the information on transmission.

3. The method according to claim 2, wherein obtaining the execution status of the upstream task comprises:
estimating an execution time remaining for the upstream task.

4. The method according to claim 2, wherein obtaining information on transmission comprises:
estimating a transmission time for the intermediate data to the downstream task.

5. The method according to claim 3, wherein the execution time remaining for the upstream task is estimated at least partially based on resource contention of the upstream task.

6. The method according to claim 2, wherein determining data dependency comprises:
establishing a comparison the execution time remaining for the upstream task and the transmission time of the intermediate data.

7. The method according to claim 1, wherein selecting time for initiating the downstream task comprises:
initiating the downstream task in response to the execution time remaining for the upstream task being less than or equal to the transmission time of the intermediate data.

8. The method according to claim 1, further comprising:
estimating resource contention for the downstream task, wherein time for initiating the downstream task is selected based on the data dependency and the resource contention for the downstream task.

9. The method according to claim 1, wherein the job is processed based on the MapReduce, wherein the upstream task comprises a Map task and the downstream task comprises a Reduce task.

10. An apparatus for parallel processing of a job, the apparatus comprising:
a determining unit configured to quantitatively determine data dependency between an upstream task and a downstream task, wherein processing of the job comprises at least first executing the upstream task and subsequently executing the downstream task; and
a selecting unit configured to select a time for initiating the downstream task at least partially based on the data dependency.

11. The apparatus according to claim 10, wherein the determining unit is configured
to obtain an execution status of the upstream task; and
to obtain an information on transmission of an intermediate data generated by the upstream task towards the downstream task,
and further configured to determine the data dependency at least partially based on the execution status and the information on transmission.

12. The apparatus according to claim 11, wherein the determining unit comprises a first obtaining unit is configured to obtain the execution status of the upstream task and a second obtaining unit is configured to obtain the information on transmission of the intermediate data generated by the upstream task towards the downstream task.

13. The apparatus according to claim 12, wherein at least one of the first obtaining unit and the determining unit comprises a unit configured to estimate execution time remaining for the upstream task, and
the second obtaining unit comprises a unit configured to estimate a transmission time of the intermediate data for the downstream task.

14. The apparatus according to claim 13, wherein the execution time remaining for the upstream task is estimated at least partially based on resource contention of the upstream task.

15. The apparatus according to claim 11, wherein the determining unit is configured to establish a comparison between the execution time remaining for the upstream task and the transmission time of the intermediate data.

16. The apparatus according to claim 13, wherein the selecting unit comprises:
a unit configured to initiate the downstream task in response to the execution time remaining for the upstream task being less than or equal to the transmission time of the intermediate data.

17. The apparatus according to claim 10, further configured to estimate resource contention of the downstream task, wherein time for initiating the downstream task is selected based on the data dependency and the resource contention of the downstream task.

18. The apparatus according to claim 17, wherein estimating resource contention is performed by an estimating unit.

19. The apparatus according to claim 9, wherein the job is processed based on the MapReduce, and wherein the upstream task comprises a Map task and the downstream task comprises a Reduce task.
